(19) United States
(12) Patent Application Publication
(10) Pub. No.: US 2026/0145666 A1
(43) Pub. Date: May 28, 2026

(54) AUTOMATED VALET PARKING SYSTEM AND AUTOMATED VALET PARKING METHOD

(71) Applicant: TOYOTA JIDOSHA KABUSHIKI KAISHA, Toyota-shi (JP)

(72) Inventors: Kazuhito ESHIMA, Toyota-shi (JP); Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/380,888

(22) Filed: Nov. 5, 2025

(30) Foreign Application Priority Data
Nov. 22, 2024 (JP) 2024-203763

(51) Int. Cl. B60W 30/06

(52) U.S. Cl. CPC B60W 30/06; B60W 2556/45

(57) ABSTRACT

After a first request that requests check-in or check-out of a vehicle is received from a user terminal of the vehicle, when a second request that conflicts with the first request is further received from the user terminal, it is determined whether a pullback condition for the vehicle is satisfied. When it is determined that the pullback condition is satisfied, a pullback instruction for pulling the vehicle back to a departure point in automated valet parking of the vehicle is transmitted to a control device of the vehicle.

### CROSS-REFERENCE TO RELATED APPLICATION

This application claims priority to Japanese Patent Application No. 2024-203763 filed on November 22, 2024. The disclosure of the above-identified application, including the specification, drawings, and claims, is incorporated by reference herein in its entirety.

### BACKGROUND

### 1. Technical Field

The present disclosure relates to an automated valet parking (AVP) system and method of a vehicle within a predetermined area such as a parking lot.

### 2. Description of Related Art

Japanese Unexamined Patent Application Publication (Translation of PCT Application) No. 2024-527070 (JP 2024-527070 A) discloses a system that assists AVP of a vehicle executed in a parking facility. The parking facility includes a pickup and drop-off place where transfer of a vehicle between a user who uses the AVP and the parking facility is executed. Specifically, at the time of check-in of the vehicle, the vehicle is transferred from the user to the parking facility. At the time of check-out of the vehicle, the vehicle is transferred from the parking facility to the user. The assist system adjusts the time required for the transfer of the vehicle.

### SUMMARY

When the vehicle is transferred from the user to the parking facility, a computer (e.g., the assist system) executes a check-in process of the vehicle. In the check-in process, the vehicle executes a check-in operation from the pickup and drop-off place to a parking space in accordance with a check-in instruction from the computer.

The user transfers the vehicle to the parking facility based on his/her own check-in intention. Thus, it is considered that there are almost no cases in which the user intervenes in the check-in process during the check-in process. However, a case in which the user requests a pullback of the vehicle to a departure point after conveyance of the check-in intention for a reason such as something being left behind in the vehicle is assumed. However, once the check-in operation is started, it is difficult to comply with this request.

Such a problem of the pullback of the vehicle is also assumed at a check-out process of the vehicle executed by the computer. For example, a case in which a user who has conveyed his/her own check-out intention to the parking facility remembers something to do after the conveyance of the check-out intention is assumed. In this case, a case in which the user requests a pullback of the vehicle to the departure point after the conveyance of the check-out intention is assumed. However, once a check-out operation is started, it is difficult to comply with this request.

The present disclosure provides an AVP technique that enables a pullback of a vehicle to a departure point after a check-in or check-out intention of a user is conveyed to a parking facility.

A first aspect of the present disclosure is an automated valet parking system that executes automated valet parking of a vehicle within a predetermined area.

The automated valet parking system includes a management device, a control device of the vehicle, and a user terminal of the vehicle. The management device is configured to manage the automated valet parking. The control device and the user terminal are configured to communicate with the management device.

The management device is configured to, in an automated valet parking process of the vehicle, determine whether a pullback condition for the vehicle is satisfied when, after receiving a first request that requests check-in or check-out of the vehicle from the user terminal, the management device further receives a second request that conflicts with the first request from the user terminal, and transmit, to the control device, a pullback instruction for pulling the vehicle back to a departure point in the automated valet parking of the vehicle based on the second request when it is determined that the pullback condition is satisfied.

In the automated valet parking system according to the first aspect of the present disclosure, the pullback condition may include that a required time required for the vehicle to travel through a pullback path from a current point of the vehicle to the departure point is equal to or less than a predetermined time.

In the automated valet parking system according to the first aspect of the present disclosure, when the first request is a check-in request of the vehicle, the pullback condition may further include that a distance from the departure point to a position of the user terminal is equal to or less than a predetermined distance.

In the automated valet parking system according to the first aspect of the present disclosure, the management device may be configured to, in the automated valet parking process, determine whether another vehicle is present on a pullback path from a current point of the vehicle to the departure point when it is determined that the pullback condition is satisfied. The management device may be configured to generate the pullback instruction including information for backward traveling on the pullback path when it is determined that the other vehicle is not present on the pullback path.

In the automated valet parking system according to the first aspect of the present disclosure, the management device may be configured to generate the pullback instruction including information for forward traveling on the pullback path when it is determined that the other vehicle is present on the pullback path.

In the automated valet parking system according to the first aspect of the present disclosure, the management device may be configured to, in the automated valet parking process, determine whether a starting operation of the vehicle from the departure point that is executed in response to the first request has started before determining whether the pullback condition is satisfied, when the management device further receives the second request from the user terminal. The management device may be configured to transmit a cancel instruction for execution of the automated valet parking to the control device when it is determined that the starting operation has not started.

In the automated valet parking system according to the first aspect of the present disclosure, the management device may be configured to, in the automated valet parking process, calculate a predicted time for the vehicle to return to the departure point and transmit the predicted time to the user terminal when it is determined that the pullback condition is satisfied.

A second aspect of the present disclosure is a method that causes a computer to execute automated valet parking of a vehicle within a predetermined area.

The method includes determining whether a pullback condition for the vehicle is satisfied when, after receiving a first request that requests check-in or check-out of the vehicle from a user terminal of the vehicle, further receiving a second request that conflicts with the first request, and transmitting, to a control device of the vehicle, a pullback instruction for pulling the vehicle back to a departure point in the automated valet parking of the vehicle based on the second request when it is determined that the pullback condition is satisfied.

With the present disclosure, after the first request that requests check-in or check-out of the vehicle is received from the user terminal of the vehicle, when the second request that conflicts with the first request is further received from the user terminal, it is determined whether the pullback condition for the vehicle is satisfied. When it is determined that the pullback condition is satisfied, the pullback instruction for pulling the vehicle back to the departure point in automated valet parking is transmitted to the control device of the vehicle. That is, the present disclosure enables the pullback of the vehicle in line with the second request by the determination of the pullback condition triggered by the reception of the second request. This leads to improvement in user convenience.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an automated valet parking system;

FIG. 2 is a diagram showing a configuration example of a vehicle system;

FIG. 3 is a conceptual diagram showing a basic flow of an AVP process;

FIG. 4 is a conceptual diagram for describing characteristics of the AVP process;

FIG. 5 is a flowchart showing a first processing example of a computer related to a pullback process; and

FIG. 6 is a flowchart showing a second processing example of the computer related to the pullback process.

### DETAILED DESCRIPTION OF EMBODIMENTS

Hereinbelow, an embodiment of the present disclosure will be described with reference to the drawings. Note that identical or equivalent parts are designated by the same reference signs throughout the drawings to simplify or omit the description thereof.

### 1. Entire Configuration Example of System

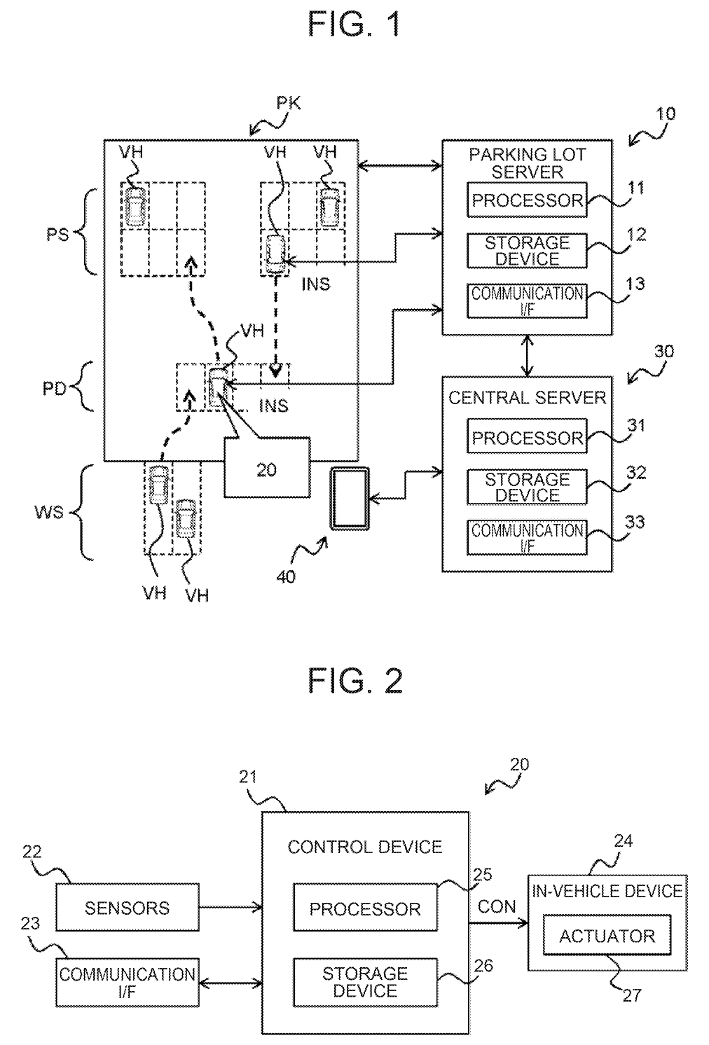

An AVP system is a system that automatically executes a parking operation of a vehicle within a predetermined area such as a parking lot, a factory, or the site of a facility. The present disclosure is applicable to autonomous driving. FIG. 1 is a diagram showing a configuration example of the AVP system. FIG. 1 illustrates a parking lot PK as the predetermined area. The parking lot PK has a configuration capable of executing AVP. The configuration capable of executing AVP includes a pickup and drop-off space PD, a waiting space WS, and a parking space PS.

The pickup and drop-off space PD is a space for getting out of a vehicle VH and/or getting into the vehicle VH. The vehicle VH may be an autonomous vehicle. The waiting space WS is a space for the vehicle VH to temporarily wait before entering the pickup and drop-off space PD. The waiting space WS is provided, for example, near an entrance of the parking lot PK. A movement of the vehicle VH from the waiting space WS to the pickup and drop-off space PD is executed by an operation of a driver of the vehicle VH. The parking space PS is a space for parking the vehicle VH. The configuration capable of executing AVP also includes, for example, a marker that assists the movement of the vehicle VH within the parking lot PK, and sensors (e.g., a camera, a radar) that monitor the vehicle VH.

FIG. 1 also illustrates a server (hereinbelow, also referred to as a "parking lot server") 10 that manages AVP in the parking lot PK. The parking lot server 10 executes various processes related to management of an AVP reservation in the parking lot PK. The parking lot server 10 also executes various processes related to management of operation authority for the vehicle VH required for AVP in the parking lot PK. The parking lot server 10 further acquires various types of information from the sensors in the parking lot PK and executes various processes related to the execution of AVP in the parking lot PK based on the various types of information. The parking lot server 10 may be a combination of a server (local server) that executes various processes related to the execution of AVP and a server (cloud server) that executes various processes related to the management of AVP.

The parking lot server 10 is typically a computer that includes at least one processor 11, at least one storage device 12, and a communication interface (I/F) 13. The processor 11 executes various processes. Examples of the processors 11 include a central processing unit (CPU), a graphics processing unit (GPU), an application specific integrated circuit (ASIC), and a field-programmable gate array (FPGA). The processor 11 may also be called "circuitry" or "processing circuitry". The "circuitry" is hardware programmed to implement the described functions, or hardware that executes the functions. The processor 11 reads the various types of information from the storage device 12 and stores the various types of information in the storage device 12.

Examples of the storage device 12 include a volatile memory, a nonvolatile memory, a hard disk drive (HDD), and a solid state drive (SSD). Examples of the various types of information stored in the storage device 12 include parking lot map information, parking lot use information, and vehicle management information. The parking lot map information indicates map information of the parking lot PK. The parking lot use information is information about a use status (availability information) of the pickup and drop-off space PD and the parking space PS within the parking lot PK. The vehicle management information includes information such as a vehicle ID, check-in and check-out times, and a vehicle position. The vehicle management information is managed for each vehicle VH. The vehicle ID is identification information of the vehicle VH. The check-in and check-out times are information about the times of check-in and check-out of the vehicle VH (e.g., reservation times, actual times). The vehicle position indicates information about the position of the vehicle VH within the parking lot PK.

The communication I/F 13 is an interface that communicates with a device outside the parking lot server 10 to transmit and receive information. For example, the communication I/F 13 includes a device for connecting to a surrounding device via a wireless LAN, a device for connecting to a mobile communication network, and a device for connecting to the Internet. The parking lot server 10 transmits and receives information to and from the vehicle VH (vehicle system 20) through the communication I/F 13. The parking lot server 10 also transmits and receives information to and from a central server 30 through the communication I/F 13.

FIG. 2 is a diagram showing a configuration example of the vehicle system 20. In the example shown in FIG. 2, the vehicle system 20 is installed in each vehicle VH as a system capable of executing AVP. In the example shown in FIG. 2, the vehicle system 20 includes a control device 21, sensors 22, a communication I/F 23, and an in-vehicle device 24.

The control device 21 is communicably connected to the sensors 22, the communication I/F 23, and the in-vehicle device 24. The control device 21 is a computer that executes information processing related to control of the vehicle VH based on various types of information. The control device 21 includes at least one processor 25, and at least one storage device 26. A configuration example of the processor 25 is the same as that of the processor 11 shown in FIG. 1. A configuration example of the storage device 26 is the same as that of the storage device 12 shown in FIG. 1. The processor 25 implements the information processing related to the control of the vehicle VH in cooperation with the storage device 26.

For example, the control device 21 includes one or more electronic control units (ECUs). In another example, the control device 21 includes a kit (e.g., an AVP kit) for functions provided by the parking lot server 10. The control device 21 generates and outputs control signals for the vehicle VH through information processing. When the vehicle VH receives an instruction INS for an AVP operation (e.g., a check-in operation, a check-out operation) from the parking lot server 10, the control device 21 generates a control signal CON for the AVP operation. The control signal CON is transmitted to the in-vehicle device 24.

The sensors 22 detect information about the surrounding environment and a traveling state of the vehicle VH. Examples of the sensors 22 include a camera, a radar, a LiDAR, a wheel speed sensor, an inertial measurement unit (IMU), and a global navigation satellite system (GNSS) sensor.

The communication I/F 23 is an interface that communicates with a device outside the vehicle VH to transmit and receive information. The vehicle VH transmits and receives information to and from the parking lot server 10 through the communication I/F 23. The vehicle VH can also transmit and receive information to and from a user terminal 40 through the communication I/F 23.

The in-vehicle device 24 includes a lighting device, an interior illumination device, a horn, a direction indicator, a wiper, a door, a door window, a mirror, a drive device, a brake device, a steering device, a human machine interface (HMI), and the like. Each device of the in-vehicle device 24 includes an actuator 27 that can be controlled by the control device 21. The in-vehicle device 24 acquires a control signal from the control device 21. The control device 21 controls the in-vehicle device 24 by the actuator 27 operating in accordance with the control signal. In addition, the control of the vehicle VH is implemented through the control of the in-vehicle device 24. Vehicle control for the AVP operation is implanted by the actuator 27 operating in accordance with the control signal CON for the AVP operation.

Referring back to FIG. 1, the description of the overall configuration example will be continued. FIG. 1 also illustrates the central server 30. The central server 30 is a server (cloud server) that manages the entire AVP service. The central server 30, together with the parking lot server 10, corresponds to a "management device" of the present disclosure. The central server 30 manages a user who uses the AVP service (hereinbelow, also referred to as an "AVP user"), a vehicle including the vehicle system 20 (i.e., the vehicle VH), and the like. The driver of the vehicle VH is an example of the AVP user. The management of the AVP user includes authentication of the AVP user and management of an AVP reservation made by the AVP user. The management of the vehicle VH includes management of vehicle information of the vehicle VH, management of operation authority for the vehicle VH, and management of an AVP operation log of the vehicle VH.

The central server 30 is typically a computer including at least one processor 31, at least one storage device 32, and a communication I/F 33. A configuration example of the processor 31 is the same as that of the processor 11. A configuration example of the storage device 32 is the same as that of the storage device 12.

Examples of various types of information stored in the storage device 32 include AVP reservation information, user information, and AVP vehicle information. The AVP reservation information is information about an AVP reservation made by the AVP user. The AVP reservation information includes information such as a parking lot that the AVP user wishes to use and check-in and check-out times. The user information includes a user ID of the AVP user, a vehicle ID of the vehicle used by the AVP user, and the like. The user information is managed for each AVP user. The AVP vehicle information includes information such as a vehicle ID of the vehicle including the vehicle system 20, an IP address of the vehicle system 20, and an AVP operation log generated by the vehicle system 20.

The communication interface I/F 33 is an interface that communicates with a device outside the central server 30 to transmit and receive information. For example, the communication I/F 33 includes a device for connecting to a surrounding device via a wireless LAN, a device for connecting to a mobile communication network, and a device for connecting to the Internet. The central server 30 transmits and receives information to and from the parking lot server 10 through the communication I/F 33. The central server 30 also transmits and receives information to and from the user terminal 40 through the communication I/F 33.

The user terminal 40 is a terminal carried by the AVP user (e.g., a smartphone). The user terminal 40 corresponds to a "user terminal" in the present disclosure. The AVP user transmits and receives information to and from the vehicle VH (vehicle system 20) by operating the user terminal 40. The AVP user also transmits and receives information to and from the central server 30 by operating the user terminal 40. The user terminal 40 is used for use registration and use reservation of the AVP service by the AVP user. The user terminal 40 is also used as appropriate at AVP at the parking lot PK. Instead of operating the user terminal 40, information about the AVP may be transmitted and received by operating the in-vehicle device 24 (e.g., the HMI) shown in FIG. 2.

### 2. AVP Process

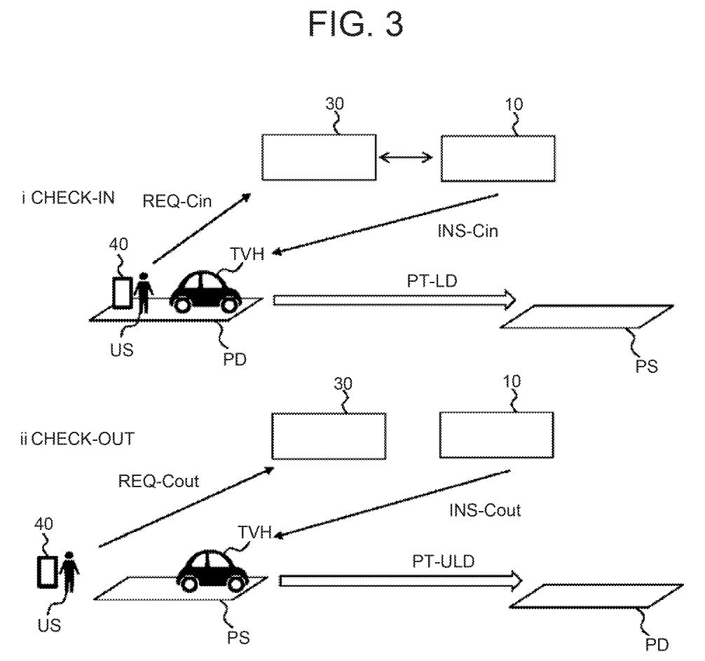

FIG. 3 is a conceptual diagram showing a basic flow of the AVP process. The upper part of FIG. 3 is a diagram showing a flow of a check-in process as the AVP process. A user US shown in the upper part of FIG. 3 is the driver of the vehicle VH that is a target of the AVP process (hereinbelow, also referred to as a "target vehicle TVH"), and is also the AVP user. The user US operates the user terminal 40 to transmit a check-in request REQ-Cin of the target vehicle TVH to the central server 30. The transmission of the check-in request REQ-Cin may be executed in the pickup and drop-off space PD or at a location away from the pickup and drop-off space PD (e.g., the waiting space WS). The check-in request REQ-Cin may be executed inside the target vehicle TVH or outside the target vehicle TVH.

When the central server 30 (processor 31) receives the check-in request REQ-Cin, the central server 30 transmits, to the parking lot server 10, AVP reservation information, user information, AVP vehicle information, and the like corresponding to the check-in request REQ-Cin, in addition to the check-in request REQ-Cin. The parking lot server 10 (processor 11) identifies the vehicle VH of the user US (i.e., the target vehicle TVH) based on these pieces of information and executes the check-in process for the vehicle VH.

At the execution of the check-in process, the parking lot server 10 acquires operation authority for the target vehicle TVH from the central server 30. The transfer of the operation authority to the parking lot server 10 enables the parking lot server 10 to execute the check-in process for the target vehicle TVH. The parking lot server 10 generates an instruction (check-in instruction) INS-Cin for the check-in operation of the target vehicle TVH and transmits the check-in instruction INS-Cin to the vehicle system 20. The check-in instruction INS-Cin includes information about a check-in path PT-LD from the pickup and drop-off space PD to the parking space PS. The check-in path PT-LD includes, for example, a plurality of path points. Each of the path points includes at least information about a target position of the target vehicle TVH.

The vehicle system 20 (processor 25) generates a control signal CON for the target vehicle TVH to travel along the check-in path PT-LD and controls the actuator 27. For example, the vehicle system 20 sets a travel plan for following the check-in path PT-LD based on information included in each path point and information about the surrounding environment and the traveling state of the target vehicle TVH. Then, the vehicle system 20 calculates a deviation (e.g., a speed deviation, a lateral position deviation, a yaw angle deviation) between the set travel plan and the target vehicle TVH, generates a control target value (e.g., a target acceleration, a target steering angle) such that the deviation decreases, and transmits the control signal CON to the actuator 27 (e.g., a drive actuator, a brake actuator, and a steering actuator). Accordingly, vehicle control for the check-in operation from the pickup and drop-off space PD to the parking space PS is executed.

The lower part of FIG. 3 is a diagram showing a flow of a check-out process as the AVP process. The flow of the check-out process is basically the same as that of the check-in process. That is, the user US transmits a check-out request REQ-Cout of the vehicle VH to the central server 30 using the user terminal 40. The transmission of the check-out request REQ-Cout may be executed in the pickup and drop-off space PD or at a location away from the pickup and drop-off space PD (a location away from the parking lot PK).

When the central server 30 receives the check-out request REQ-Cout, the central server 30 transmits, to the parking lot server 10, AVP reservation information, user information, AVP vehicle information, and the like corresponding to the check-out request REQ-Cout, in addition to the check-out request REQ-Cout. The parking lot server 10 identifies the vehicle VH of the user US (i.e., the target vehicle TVH) based on these pieces of information and executes the check-out process for the vehicle VH.

The parking lot server 10 generates an instruction (check-out instruction) INS-Cout for the check-out operation of the target vehicle TVH and transmits the check-out instruction INS-Cout to the vehicle system 20. The check-out instruction INS-Cout includes information about a check-out path PT-ULD from the parking space PS to the pickup and drop-off space PD. A configuration example of the check-out path PT-ULD is the same as that of the check-in path PT-LD. That is, the check-out path PT-ULD includes, for example, a plurality of path points. Each of the path points includes at least information about a target position of the target vehicle TVH.

The vehicle system 20 generates a control signal CON for the target vehicle TVH to travel along the check-out path PT-ULD and controls the actuator 27. An example of the control of the actuator 27 based on the control signal CON is the same as that at the check-in process. Accordingly, vehicle control for the check-out operation from the parking space PS to the pickup and drop-off space PD is executed. When the target vehicle TVH reaches the pickup and drop-off space PD, the parking lot server 10 transmits and receives information to and from the central server 30 and returns the operation authority for the target vehicle TVH. The transfer of the operation authority to the central server 30 finishes the AVP of the target vehicle TVH executed by the parking lot server 10.

### 3. Characteristics of AVP Process

### 3-1. Check-in Process

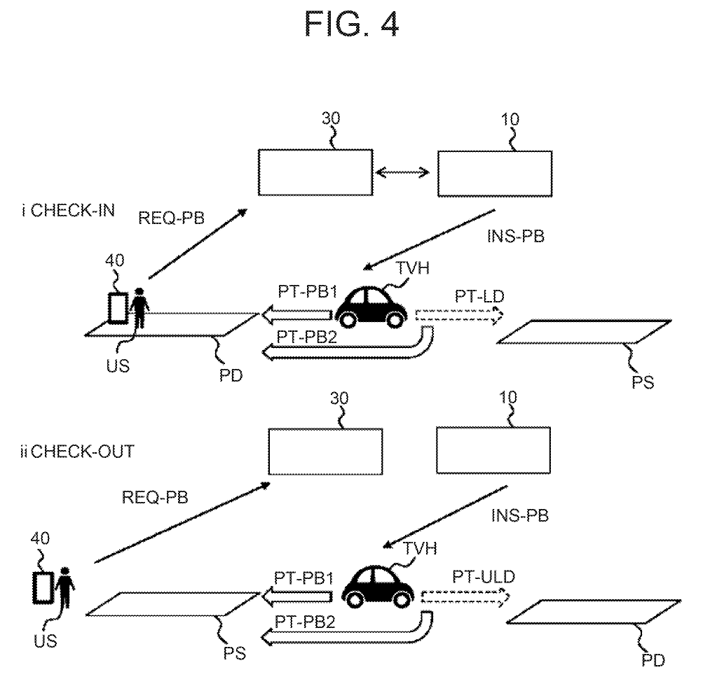

FIG. 4 is a conceptual diagram for describing the characteristics of the AVP process. The upper part of FIG. 4 shows a state after the check-in operation of the target vehicle TVH is started in response to the execution of the check-in process shown in the upper part of FIG. 3. When the check-in process is executed, the target vehicle TVH starts to move and moves away from the pickup and drop-off space PD.

The user US leaves the pickup and drop-off space PD before the start of the check-in process, or leaves the pickup and drop-off space PD after the start of the check-in process. However, it is assumed that the user US wishes to cancel the check-in request REQ-Cin for some reason.

For example, a case in which the user US remembers that there is a thing left behind in a cabin of the target vehicle TVH is considered. In this case, it is expected that the user US attempts to chase the target vehicle TVH to pick up the left thing. However, the operation authority for the target vehicle TVH has been transferred to the parking lot server 10. Thus, it is difficult for the user US to stop the check-in operation of the target vehicle TVH. In addition, in some cases, the entry of any person into an area of the parking lot PK excluding the pickup and drop-off space PD is prohibited for the safe execution of AVP. Therefore, once the check-in operation is started, it is difficult to cancel the check-in request REQ-Cin.

To solve such a problem, the check-in process according to the embodiment enables a request that conflicts with the check-in request REQ-Cin to be accepted after the reception of the check-in request REQ-Cin. In the example shown in FIG. 4, a pullback request REQ-PB is shown as the request that conflicts with the check-in request REQ-Cin. Note that the check-in request REQ-Cin is an example of a "first request" in the present disclosure, and the pullback request REQ-PB is an example of a "second request". The pullback request REQ-PB may be a cancel request for the check-in request REQ-Cin or may be the check-out request REQ-Cout.

The pullback request REQ-PB is transmitted from the user terminal 40 to the central server 30. When the central server 30 receives the pullback request REQ-PB, the central server 30 transmits, to the parking lot server 10, user information, AVP vehicle information, and the like corresponding to the pullback request REQ-PB, in addition to the pullback request REQ-PB. The parking lot server 10 identifies the vehicle VH of the user US (i.e., the target vehicle TVH) based on these pieces of information and executes a pullback process for the vehicle VH.

At the execution of the pullback process for the target vehicle TVH, the parking lot server 10 determines whether a pullback condition (hereinbelow, also referred to as a "PB condition") is satisfied. The following conditions i and ii are examples of the PB condition.

i A required time Tr required for the target vehicle TVH to travel along a pullback path PT-PB from the current point of the target vehicle TVH to the departure point (i.e., the position of the pickup and drop-off space PD) is equal to or less than a predetermined time Ta.

ii A distance Dr from the departure point (i.e., the position of the pickup and drop-off space PD) to the position of the user terminal 40 is equal to or less than a predetermined distance Da.

The predetermined time Ta is, for example, the time that is acceptable as the pullback time for the target vehicle TVH based on the configuration of the parking lot PK (e.g., the number of passages directly connected to the pickup and drop-off space PD, the shape of the passages, the width of the passages). The predetermined time Ta may be adjusted based on information such as the total number of other vehicles VH that are waiting in the waiting space WS, and the total number of other vehicles VH that are executing the AVP operation on the passages directly connected to the pickup and drop-off space PD. The predetermined distance Da is, for example, a distance by which a person can move on foot within the predetermined time Ta.

When both the conditions i and ii are satisfied, the parking lot server 10 determines that the PB condition is satisfied and executes the pullback process. In the pullback process, the parking lot server 10 generates an instruction (pullback instruction) INS-PB for the pullback operation of the target vehicle TVH and transmits the pullback instruction INS-PB to the vehicle system 20. The pullback instruction INS-PB includes information about the pullback path PT-PB. A configuration example of the pullback path PT-PB is the same as that of the check-in path PT-LD. That is, the pullback path PT-PB includes, for example, a plurality of path points. Each of the path points includes at least information about a target position of the target vehicle TVH.

Examples of the pullback path PT-PB includes a path PT-PB1 for backward traveling and a path PT-PB2 for forward traveling. The target vehicle TVH that has started to move from the pickup and drop-off space PD in response to the execution of the check-in process is traveling forward. Thus, to return from the current position of the target vehicle TVH to the departure point (i.e., the position of the pickup and drop-off space PD), using the path PT-PB1 is more likely to be able to reduce the time required for the pullback process than using path PT-PB2.

Thus, in setting the pullback path PT-PB for the condition i, whether the following condition iii is satisfied may be determined. In addition, the path PT-PB1 may be set as the pullback path PT-PB when the following condition iii is satisfied, and the path PT-PB2 may be set as the pullback path PT-PB when the condition iii is not satisfied. iii Another vehicle VH is not present on the pullback path PT-PB.

Examples of "another vehicle" in the condition iii include the vehicle VH (following vehicle) that executes a check-in operation after the target vehicle TVH, and the vehicle VH that is executing the AVP operation.

### 3-2. Check-out Process

The lower part of FIG. 4 shows a state after the check-out operation of the target vehicle TVH is started in response to the execution of the check-out process shown in the lower part of FIG. 3. When the check-out process is executed, the target vehicle TVH starts to move and moves away from the parking space PS.

The user US arrives at the pickup and drop-off space PD before the start of the check-out process, or arrives at the pickup and drop-off space PD after the start of the check-out process. However, it is assumed that the user US wishes to cancel the check-out request REQ-Cout for some reason.

For example, a case in which the user US remembers a thing to do other than the check-out is considered. In this case, it is expected that the user US leaves the pickup and drop-off space PD in order to finish the thing to do. In this case, it is expected that the user US wishes to suspend the execution of the check-out process until the thing to do is finished.

Thus, the check-out process according to the embodiment enables a request that conflicts with the check-out request REQ-Cout to be accepted after the reception of the check-out request REQ-Cout. In the example shown in FIG. 4, the pullback request REQ-PB is shown as the request that conflicts with the check-out request REQ-Cout. Note that the check-out request REQ-Cout is an example of the "first request" in the present disclosure, and the pullback request REQ-PB is an example of the "second request". The pullback request REQ-PB may be a cancel request for the check-out request REQ-Cout or may be the check-in request REQ-Cin.

A basic flow of the pullback process for the target vehicle TVH based on the pullback request REQ-PB is common between at the time of check-in and at the time of check-out. However, in the pullback process at the time of check-out, only determination for a condition iv corresponding to the condition i is executed, and determination for the condition ii is not executed. iv The required time Tr required for the target vehicle TVH to travel along the pullback path PT-PB from the current point of the target vehicle TVH to the departure point (i.e., the position of the parking space PS) is equal to or less than a predetermined time Tb.

The predetermined time Tb is, for example, the time that is acceptable as the pullback time for the target vehicle TVH based on the configuration of the parking lot PK (e.g., the number of passages directly connected to the parking space PS, the shape of the passages, the width of the passages). The predetermined time Tb may be adjusted based on information such as the total number of other vehicles VH that are executing the AVP operation on the passages directly connected to the parking space PS.

When the condition iv is satisfied, the parking lot server 10 determines that the PB condition is satisfied and executes the pullback process. In the pullback process, the parking lot server 10 generates a pullback instruction INS-PB and transmits the pullback instruction INS-PB to the vehicle system 20. The pullback instruction INS-PB includes information about the pullback path PT-PB. A configuration example of the pullback path PT-PB is the same as that of the check-out path PT-ULD.

The pullback path PT-PB at the time of check-out includes the path PT-PB1 for backward traveling and the path PT-PB2 for forward traveling, which is common to the pullback process at the time of check-in. In addition, in setting the pullback path PT-PB for the condition iv, whether the condition iii is satisfied may be determined, and the path PT-PB1 may be set as the pullback path PT-PB when condition iii is satisfied and the path PT-PB2 may be set as the pullback path PT-PB when the condition iii is not satisfied, which is common to the pullback process at the time of check-in.

### 4. Computer Processing Example

### 4-1. First Processing Example

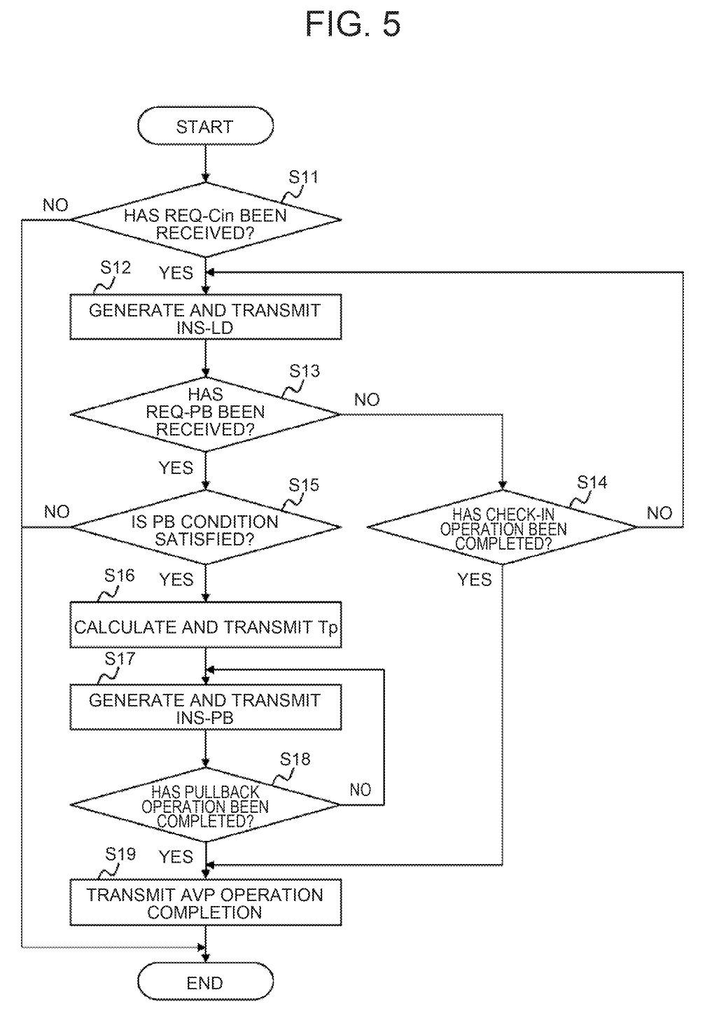

FIG. 5 is a flowchart showing a first processing example of the computer related to the pullback process. A routine shown in FIG. 5 is executed by the parking lot server 10 (processor 11) shown in FIG. 1. The routine shown in FIG. 5 is started, for example, when the target vehicle TVH is recognized at the pickup and drop-off space PD.

In the example shown in FIG. 5, in a process of step S11, it is determined whether the check-in request REQ-Cin for the target vehicle TVH has been received. As already described, the check-in request REQ-Cin is transmitted from the user terminal 40 to the parking lot server 10 through the central server 30. In addition, information such as AVP reservation information, user information, AVP vehicle information, and the like corresponding to the check-in request REQ-Cin are transmitted from the central server 30 to the parking lot server 10. In the process of step S11, based on these pieces of information, it is determined whether the check-in request REQ-Cin is for the target vehicle TVH.

When it is determined in step S11 that the check-in request REQ-Cin has not been received or the check-in request REQ-Cin is not for the target vehicle TVH, the process is finished. On the other hand, when it is determined that the check-in request REQ-Cin is for the target vehicle TVH, a process of step S12 is executed. In the process of step S12, the check-in instruction INS-Cin is generated and transmitted to the vehicle system 20 of the target vehicle TVH. Note that, in the process of step S12, the operation authority for the target vehicle TVH is transferred from the central server 30 to the parking lot server 10.

Following the process of step S12, a process of step S13 is executed. In the process of step S13, it is determined whether the pullback request REQ-PB for the target vehicle TVH has been received. As with the check-in request REQ-Cin, the pullback request REQ-PB is transmitted from the user terminal 40 to the parking lot server 10 through the central server 30. In addition, user information, AVP vehicle information, and the like corresponding to the pullback request REQ-PB are transmitted from the central server 30 to the parking lot server 10. In the process of step S13, based on these pieces of information, it is determined whether the pullback request REQ-PB is for the target vehicle TVH.

When it is determined in step S13 that the pullback request REQ-PB has not been received or the pullback request REQ-PB is not for the target vehicle TVH, a process of step S14 is executed. In the process of step S14, it is determined whether the check-in operation of the target vehicle TVH has been completed. A progress status of the check-in operation is grasped based on, for example, the check-in path PT-LD and the current position of the target vehicle TVH. When it is determined that the check-in operation of the target vehicle TVH has not been completed, the process returns to the process of step S12.

When it is determined in step S13 that the pullback request REQ-PB for the target vehicle TVH has been received, a process of step S15 is executed. In the process of step S15, it is determined whether the PB condition is satisfied. Examples of the PB condition include the conditions i and ii described above. As already described, whether the condition iii is satisfied may be determined in the determination of the condition i. When it is determined that the PB condition is not satisfied, the process is finished. Before the process is finished, information indicating that a pullback following the pullback request REQ-PB cannot be executed and information indicating the reason thereof (e.g., the condition i is not satisfied) may be transmitted to the user terminal 40 through the central server 30.

When it is determined in step S15 that the PB condition is satisfied, a process of step S16 is executed. In the process of step S16, a predicted time Tp for the target vehicle TVH to return to the departure point (i.e., the position of the pickup and drop-off space PD) is calculated and transmitted to the user terminal 40 through the central server 30. The predicted time Tp is the required time Tr calculated in the PB condition (condition i) in step S15. The predicted time Tp may be time information calculated based on the current time and the required time Tr.

Following the process of step S16, a process of step S17 is executed. In the process of step S17, the pullback instruction INS-PB is generated and transmitted to the vehicle system 20 of the target vehicle TVH.

Following the process of step S17, a process of step S18 is executed. In the process of step S18, it is determined whether the pullback operation of the target vehicle TVH has been completed. A progress status of the pullback operation is grasped based on, for example, the pullback path PT-PB and the current position of the target vehicle TVH. When it is determined that the pullback operation of the target vehicle TVH has not been completed, the process returns to the process of step S17.

When it is determined in step S18 that the pullback operation of the target vehicle TVH has been completed, a process of step S19 is executed. The process of step S19 is also executed when it is determined in step S14 that the check-in operation of the target vehicle TVH has been completed. In the process of step S19, information indicating that the AVP operation (the check-in operation or the pullback operation) has been completed is transmitted to the user terminal 40 through the central server 30.

### 4-2. Second Processing Example

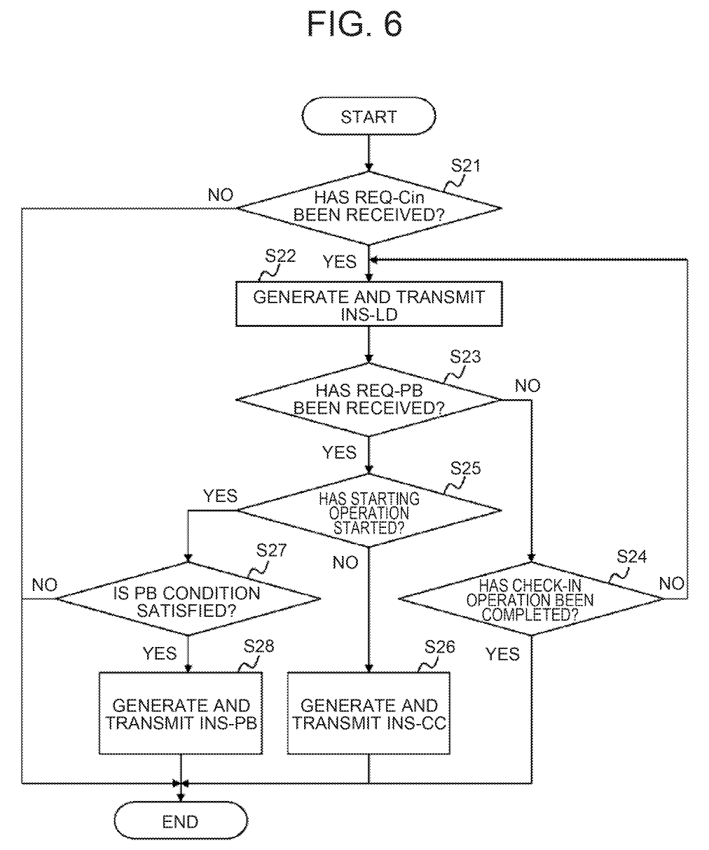

FIG. 6 is a flowchart showing a second processing example of the computer related to the pullback process. A routine shown in FIG. 6 is executed by the parking lot server 10 (processor 11) shown in FIG. 1 instead of the routine shown in FIG. 5, for example.

Processes of steps S21 to S24 shown in FIG. 6 are the same as the processes of steps S11 to S14 shown in FIG. 5. In addition, processes of steps S27 and S28 shown in FIG. 6 are the same as the processes of steps S15 and S17 shown in FIG. 5.

In the example shown in FIG. 6, when it is determined in step S23 that the pullback request REQ-PB for the target vehicle TVH has been received, a process of step S25 is executed. In the process of step S25, it is determined whether a starting operation of the target vehicle TVH has started. Whether the starting operation has started is determined based on the progress status of the check-in operation of the target vehicle TVH.

When it is determined in step S25 that the starting operation of the target vehicle TVH has not yet started, a process of step S26 is executed. In the process of step S26, an instruction (cancel instruction) INS-CC for canceling the execution of the check-in process is generated and transmitted to the vehicle system 20 of the target vehicle TVH. Accordingly, the execution of the check-in process for the target vehicle TVH is canceled, and the check-in operation of the target vehicle TVH including the starting operation is not started. On the other hand, when it is determined that the starting operation of the target vehicle TVH has already started, a process of step S27 is executed.

That is, when the process of step S26 is executed, the execution of the check-in process is canceled without executing the determination of the PB condition in step S27. In this manner, with the second processing example, it is possible to keep the vehicle VH at the departure point without executing the determination of the PB condition. This leads to a reduction in a processing load on the parking lot server 10.

Although not shown in FIG. 6, the process corresponding to step S16 described with reference to FIG. 5 may be executed between the process of step S27 and the process of step S28 shown in FIG. 6. In addition, the processes corresponding to the processes of steps S18 and S19 described with reference to FIG. 5 may be executed following the process of step S24 (when the determination is YES) and step S28 shown in FIG. 6.

### 4-3. Processing Example at Check-out

The first and second processing examples described with reference to FIGS. 5 and 6 relate to the pullback process at the time of check-in. The first and second processing examples are also applicable to the pullback process at the time of check-out. When the first and second processing examples are applied to the pullback process at the time of check-out, in the description with reference to FIGS. 5 and 6, the "check-in process" is replaced with the "check-out process", the "pickup and drop-off space PD" is replaced with the "parking space PS", the "check-in request REQ-Cin" is replaced with the "check-out request REQ-Cout", and the "conditions i and ii" are replaced with the "condition iv". Accordingly, a computer processing example related to the pullback process at the time of check-out is described.

What is claimed is:

1. An automated valet parking system configured to execute automated valet parking of a vehicle within a predetermined area, the automated valet parking system comprising:
a management device configured to manage the automated valet parking;
a control device of the vehicle configured to communicate with the management device; and
a user terminal of the vehicle configured to communicate with the management device, wherein
the management device is configured to,
in an automated valet parking process of the vehicle,
determine whether a pullback condition for the vehicle is satisfied when, after receiving a first request that requests check-in or check-out of the vehicle from the user terminal, the management device further receives a second request that conflicts with the first request from the user terminal, and
transmit, to the control device, a pullback instruction for pulling the vehicle back to a departure point in the automated valet parking of the vehicle when it is determined that the pullback condition is satisfied.

2. The automated valet parking system according to claim 1, wherein the pullback condition includes that a required time required for the vehicle to travel through a pullback path from a current point of the vehicle to the departure point is equal to or less than a predetermined time.

3. The automated valet parking system according to claim 2, wherein when the first request is a check-in request of the vehicle, the pullback condition further includes that a distance from the departure point to a position of the user terminal is equal to or less than a predetermined distance.

4. The automated valet parking system according to claim 1, wherein
the management device is configured to,
in the automated valet parking process,
determine whether another vehicle is present on a pullback path from a current point of the vehicle to the departure point when it is determined that the pullback condition is satisfied, and
generate the pullback instruction including information for backward traveling on the pullback path when it is determined that the other vehicle is not present on the pullback path.

5. The automated valet parking system according to claim 4, wherein the management device is configured to generate the pullback instruction including information for forward traveling on the pullback path when it is determined that the other vehicle is present on the pullback path.

6. The automated valet parking system according to claim 1, wherein
the management device is configured to,
in the automated valet parking process,
determine whether a starting operation of the vehicle from the departure point that is executed in response to the first request has started before determining whether the pullback condition is satisfied, when the management device further receives the second request from the user terminal, and
transmit a cancel instruction for execution of the automated valet parking to the control device when it is determined that the starting operation has not started.

7. The automated valet parking system according to claim 1, wherein
the management device is configured to,
in the automated valet parking process,
calculate a predicted time for the vehicle to return to the departure point and transmit the predicted time to the user terminal when it is determined that the pullback condition is satisfied.

8. An automated valet parking method that causes a computer to execute automated valet parking of a vehicle within a predetermined area, the automated valet parking method comprising:
determining whether a pullback condition for the vehicle is satisfied when, after receiving a first request that requests check-in or check-out of the vehicle from a user terminal of the vehicle, further receiving a second request that conflicts with the first request; and
transmitting, to a control device of the vehicle, a pullback instruction for pulling the vehicle back to a departure point in the automated valet parking of the vehicle when it is determined that the pullback condition is satisfied.
